(19) United States
(12) Patent Application Publication
(10) Pub. No.: US 2011/0225267 A1
(43) Pub. Date: Sep. 15, 2011

(54) SERVER SYSTEM FOR VIEWING IN-HOUSE INFORMATION, AND METHOD OF CONTROLLING SAME

(75) Inventor: Yosuke OHASHI, Tokyo (JP)

(73) Assignee: FUJIFILM Corporation, Tokyo (JP)

(21) Appl. No.: 13/004,744

(22) Filed: Jan. 11, 2011

(30) Foreign Application Priority Data
Mar. 10, 2010 (JP) 2010-052552

(51) Int. Cl. G06F 15/16

(52) U.S. Cl. 709/219

(57) ABSTRACT

Leakage of information is prevented when information in an in-house server is viewed by a mobile telephone. A request from a mobile telephone is applied to a virtual server via the Internet, a distribution server and a virtual bridge device. The request is applied to the virtual bridge device from the virtual server, and the virtual bridge device appends a VLAN tag indicating that the request is a request for a company A. The request is input to a data center router. The router determines from the VLAN tag that the request is a request for company A and transmits the request to a LAN for company A. Thus the request is reliably applied to the LAN for company A, which is the access destination.

### BACKGROUND OF THE INVENTION

1. Field of the Invention

This invention relates to a server system for viewing in-house information and to a method of controlling this system.

2. Description of the Related Art

The growing use of mobile telephones and the like has been accompanied by the widespread proliferation of services for viewing in-house e-mail in business. Over these recent years of economic recession, e-mail viewing systems oriented toward mobile telephones often are provided by an ASP (Application Service Provider) instead of such systems being placed in-house. To a service provider who provides these mobile-telephone-oriented e-mail viewing systems as an ASP to a plurality of businesses, highly confidential information such as in-house e-mail must be handled securely without leakage to the outside or between customers, and the service must be provided more inexpensively in comparison with in-house installation.

For example, there is a server apparatus which, by associating a private network and a virtual server, is capable of providing an application while assuring privacy between users (see Japanese Patent Application Laid-Open No. 2005-100194). However, in an ASP service that provides a plurality of businesses with similar functions, it is required that applications be prepared on a per-company basis. This raises the cost of maintenance. Further, although there is a single physical server apparatus that communicates with multiple private user networks (Japanese Patent Application Laid-Open No. 2003-167805), no consideration has been given to access from terminal devices such as mobile telephones. Further, there is a communication system in which use is made of an electronic device such as a USB memory having the functions of a VPN (Virtual Private Network), firewall and virus checker. When an in-house VPN is accessed is this system, highly secure communication from a communication terminal can be achieved, even if the terminal used does not have a fully satisfactory security function, by relying upon the intermediary of a virtual network device within the electronic device (Japanese Patent Application Laid-Open No. 2007-151114). However, a separate electronic device is necessary when communication is performed.

### SUMMARY OF THE INVENTION

An object of the present invention is to provide service inexpensively while preventing leakage of confidential information before it occurs.

The present invention provides a server system for viewing in-house information, the system comprising:

an application server in which a plurality of virtual servers have been formed in correspondence with in-house LANs of clients; a distribution server, responsive to an access request from a mobile terminal to an in-house information server that has been connected to the respective in-house LAN, for connecting the mobile terminal to a virtual server corresponding to the in-house LAN to which has been connected this in-house information server to which access is requested; a virtual bridge device (virtual bridge means) for inputting data, which is applied to the virtual server corresponding to the in-house LAN to which has been connected the in-house information server to which access is requested, from the mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data; and a router for communicating data between the virtual bridge device and the in-house LAN of the client connected to a port that corresponds to the identification data appended by said virtual bridge.

The present invention also provides a control method suited to the above-described server system for viewing in-house information. Specifically, the present invention provides a method of controlling a server system for viewing in-house information, the method comprising: forming a plurality of virtual servers in correspondence with in-house LANs of clients; in response to an access request from a mobile terminal to an in-house information server that has been connected to the respective in-house LAN, connecting the mobile terminal to a virtual server corresponding to the in-house LAN to which has been connected this in-house information server to which access is requested; inputting data, which is applied to the virtual server corresponding to the in-house LAN to which has been connected the in-house information server to which access is requested, from the mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data; and communicating data between a virtual bridge device and the in-house LAN of the client connected to a port that corresponds to the appended identification data.

In accordance with the present invention, a virtual bridge device appends identification data to data applied to an in-house information server from a mobile telephone. A router communicates data between the virtual bridge device and an in-house LAN that has been connected to a port corresponding to the identification data. By applying the data to which the identification data has been appended to the router from the virtual bridge device, data from the mobile telephone is applied to the in-house LAN of the client connected to the port corresponding to this identification data. Thus the data is applied to the in-house LAN identified by the identification data and leakage of the data can be prevented. Identification data is appended also to data transmitted from the in-house LAN. When such data is input to the virtual bridge device via the router, the input data is applied to the virtual server identified by the appended identification data and the data is transmitted to the mobile telephone. The data transmitted from the in-house LAN is applied to the virtual server for this in-house LAN and identified by the identification data transmitted from the in-house LAN, and is not applied to another virtual server. This makes it possible to prevent leakage of data.

In accordance with the present invention, cost can be held down since a plurality of in-house information servers and a virtual server corresponding to these in-house servers are connected in a one-to-one relationship.

By way of example, the application server includes an application software storage device (application software storage means) in which application software used in the virtual servers has been stored. In this case, the application server would execute the application software that has been stored in the application software storage device.

By way of example, the in-house information server is an e-mail server, a file server or a web server.

The present invention also provides an application server constituting the above-described system. Specifically, the present invention provides an application server comprising: a plurality of virtual servers formed in correspondence with in-house LANs of clients; and a virtual bridge device (virtual bridge means) for inputting data, which is applied to a virtual server corresponding to an in-house LAN to which has been connected an in-house information server to which access is requested, from a mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data.

The present invention also provides a method of controlling the operation of the above-described application server. Specifically, the method comprises the steps of: forming a plurality of virtual servers in correspondence with in-house LANs of clients; and inputting data, which is applied to a virtual server corresponding to an in-house LAN to which has been connected an in-house information server to which access is requested, from a mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a system for viewing in-house information;

FIG. 2 is an example of a distribution rule table;

FIG. 3 is an example of an authentication table;

FIG. 4 is an example of an application table;

FIG. 5 is an example of an application authentication table;

FIG. 6 is a block diagram illustrating the electrical configuration of an application server;

FIG. 7 is an example of a routing table;

FIGS. 8 and 9 are flowcharts illustrating log-in processing;

FIG. 10 is an example of a log-in page;

FIG. 11 is an example of a top page;

FIGS. 12 and 13 are flowcharts illustrating processing executed in a system for viewing in-house information;

FIG. 14 is an example of a mail list page;

FIG. 15 is an example of a mail body page;

FIG. 16 is a flowchart illustrating processing executed by a distribution server and a virtual server; and

FIG. 17 is a flowchart illustrating processing executed by a virtual server and a POP server.

### DESCRIPTION OF THE PREFERRED EMBODIMENT

A preferred embodiment of the present invention will now be described with reference to the drawings.

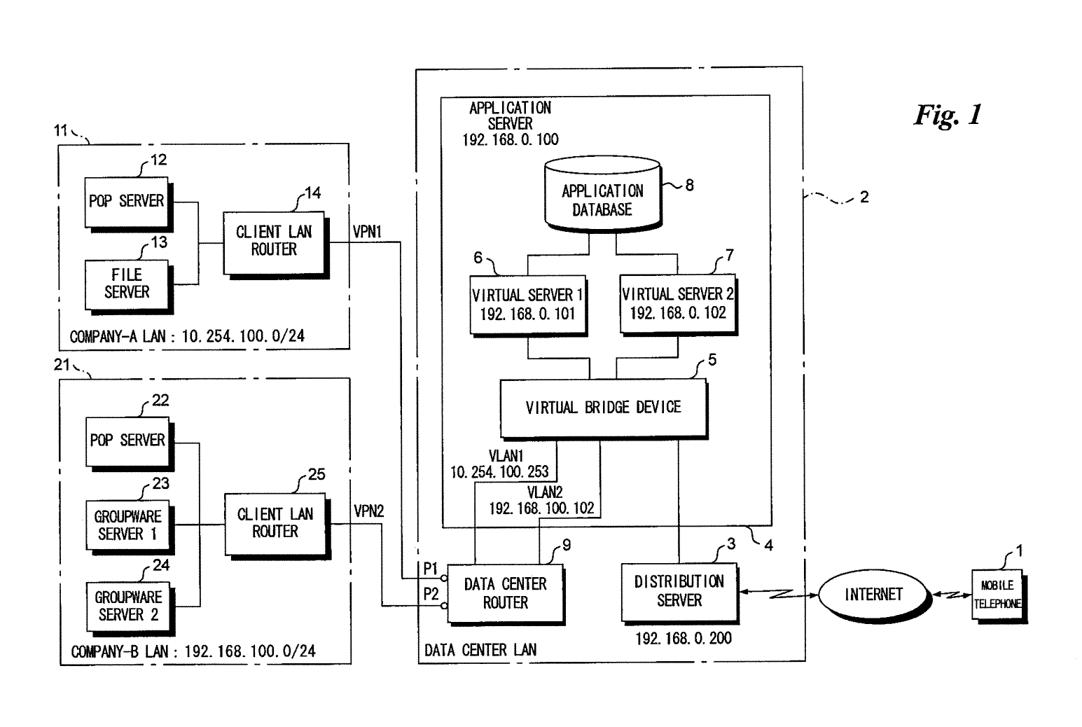

FIG. 1 is a block diagram illustrating the electrical configuration of a system for viewing in-house information according to a preferred embodiment of the present invention.

A system for viewing in-house information includes a data center LAN (local-area network) (server system for viewing in-house information) 2. The data center LAN 2 is a network containing a server for providing an information viewing function as an ASP (Application Service Provider). A LAN 11 for a company A is connected to the data center LAN 2 by a VPN1 (Virtual Private Network), and a LAN 21 for a company B is connected to the data center LAN 2 by a VPN2. A mobile telephone 1 is capable of accessing the data center LAN 2 via the Internet.

Although the LANs of two companies, namely the company-A LAN 11 and the company-B LAN 21, have been connected to the data center LAN 2 in FIG. 1, the LANs of many more companies (of any designation such as business, organization or association) may be connected. Further, although the single mobile telephone 1 is illustrated, it goes without saying that a number of mobile telephones are capable of accessing the data center LAN 2. The mobile telephone 1 that accesses the data center LAN 2 is that of an employee of a company (a client, company A or company B) that has been connected to the data center LAN 2. If the mobile telephone 1 is that of an employee of company A, then, by accessing the data center LAN 2 using the mobile telephone 1, a server that has been connected to the company-A LAN 11 can be accessed and the information that has been stored in the server can be viewed. Similarly, if the mobile telephone 1 is that of an employee of company B, then, by accessing the data center LAN 2 using the mobile telephone 1, a server that has been connected to the company-B LAN 21 can be accessed and the information that has been stored in the server can be viewed. It goes without saying that information that has been stored in a server connected to the company-A LAN 11 cannot be accessed using mobile telephone 1 of an employee other than an employee of company A, and that information that has been stored in a server connected to the company-B LAN 21 cannot be accessed using mobile telephone 1 of an employee other than an employee of company B.

The data center LAN 2 includes an application server 4. The application server 4 is a physically existing single server that actually performs an information viewing function. The data center LAN 2 further includes a distribution server 3 provided between the application server 4 and the Internet. The data center LAN 2 further includes a data center router 9 for connecting to the company-A LAN 11 via the VPN1 and to the company-B LAN 21 via the VPN2.

Formed within the application server 4 are virtual servers 6 and 7 conforming to the number of LANs of the companies that have been connected to the data center LAN 2. The virtual servers 6 and 7 are logical servers that operate in the physically existing server (the application server 4 in this case). The virtualization of a server has a plurality of stages, and there may be virtualization at the hardware level and virtualization at the kernel level of an operating system. Preferably, the virtual servers 6 and 7 have disk areas each capable of being accessed exclusively in order to assure security. However, it is preferred that the information viewing function executed commonly by the virtual server 6 or 7 be such that a specific area designated as an application area can be shared by the virtual servers 6 and 7.

Further, in order to prevent the occurrence of an exchange of data between the virtual servers 6 and 7 through the application area and to prevent an application from being changed erroneously by the virtual server 6 or 7, it is preferred that the application area be one that is readable only from the virtual servers 6 and 7. Although a folder-sharing function in an operating system is conceivable as a method of sharing the application area, other methods are available as well.

The application server 4 includes an application database 8 accessible from the virtual servers 6 and 7. The above-mentioned application area has been formed in the application database 8. Further, the application database 8 contains various tables (see FIGS. 3 to 5), described later, as well as application software executed in the virtual servers 6 and 7.

The application server 4 further includes a virtual bridge device 5. The virtual bridge device 5 connects the distribution server 3 and the virtual servers 6 and 7, and connects the data center router 9 and the virtual servers 6 and 7.

The distribution server 3 receives an access request from the mobile telephone 1, specifies the user of the mobile telephone 1 and transfers the access request to whichever of the virtual servers 6, 7 corresponds to the designated user. The distribution server 3 can be implemented utilizing a URL (Uniform Resource Locator) rewrite function and reverse proxy function, etc., possessed by a web server such as Apache. Since the distribution server 3 receives access from the mobile telephone 1, it is preferred that this server have a global IP (Internet Protocol) address and be directly connected to the Internet.

Preferably, the distribution server 3, application server 4, and virtual servers 6, 7 included in the application server 4 belong to the same network in order that these may communicate with one another. For example, by adopting 192.168.0.100 as the IP address of the application server, 192.168.0.101 as the IP address of the virtual server 6, 192.168.0.102 as the IP address of the virtual server 7 and 192.168.0.200 as the IP address of the distribution server 3, the distribution server 3, application server 4, and virtual servers 6, 7 included in the application server 4 will belong to the same network.

Access from the mobile telephone 1 to the data center LAN 2 is performed through a carrier gateway (not shown) via a wide-area network such as the Internet. Accordingly, it is preferred that access between the distribution server 3 and the mobile telephone 1 use an encrypted protocol such as HTTPS (HyperText Transfer Protocol Security).

The data center router 9 is connected to the virtual bridge device 5 of the application server 4. For every client among multiple clients, the data center router 9 connects the in-house LANs of the companies (clients) with the virtual servers 6 and 7. By virtue of the virtual bridge device 5, a VLAN1 for communicating data and commands of company A and a VLAN2 for communicating data and commands of company B are formed virtually between the data center router 9 and the virtual bridge device 5. Further, a client LAN router 14 (described later) of company A is connected via VPN1 to a first port P1 formed physically in the data center router 9, and a client LAN router 25 (described later) of company B is connected via VPN2 to a second port P2 formed physically in the data center router 9. The data center router 9 connects the in-house LANs of multiple clients to the virtual servers 6 and 7 within the application server 4 by a single physical network using the VLAN function.

By virtue of the data center router 9, the virtual server 6 for company A is connected to the company-A LAN 11 via the company-A VPN1, and the virtual server 7 of company B is connected to the company-B LAN 21 via the company-B VPN2. Since the communication path between the virtual server 6 for company A and the company-A LAN 11 and the communication path between the virtual server 7 for company B and the company-B LAN 21 are essentially independent, data and commands for company A and data and commands for company B can be prevented from mixing.

If we assume that the company-A LAN 11 has the network of 10.254.100.0/24, then the virtual server 6 for company A will belong to the LAN for company A and can have an IP address included in the network for company A, namely 10.254.100.253. Similarly, if we assume that the company-B LAN 21 has the network of 192.168.100.0/24, then the virtual server 7 for company B will belong to the LAN for company B and can have an IP address included in the network for company B, namely 192.168.100.102. Since the data and commands of company A and the data and commands of company B are communicated using different networks, mixing can be prevented. The in-house LANs of multiple clients can be connected securely to respective ones of the virtual servers for the respective clients.

In FIG. 1, two VLANs are illustrated to facilitate understanding. However, as will be described later, the two VLANs do not exist physically, and the data center router 9 is connected to the application server 4 by a single cable.

A POP (Post Office Protocol) server (e-mail server) 12 and a file server 13 (in-house information server) for sending and receiving prescribed files are connected to the company-A LAN 11. The POP server 12 and file server 13 are capable of communicating with the data center LAN 2 via the client LAN router 14 connected to the company-A LAN 11.

A POP server 22 and groupware servers 23, 24 are connected to the company-B LAN 21. The POP server 22 and groupware servers 23, 24 are capable of communicating with the data center LAN 2 via the client LAN router 25.

In this embodiment, the virtual bridge device 5 is included in the application server 4. However, it does not matter whether the virtual bridge device 5 is or is not included in the application server 4.

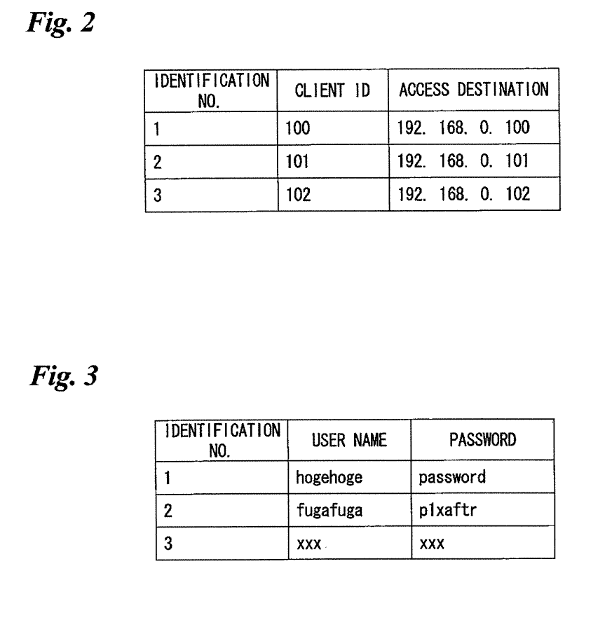

FIG. 2 is an example of a distribution rule table.

The distribution rule table has been stored in the distribution server 3. The distribution rule table stores client IDs and access destinations in correspondence with identification numbers. A client ID identifies the employee that used the mobile telephone 1 to access the distribution server 3, namely the particular company (company LAN) that has been connected to the data center LAN 2. An access destination indicates the IP address of a transfer destination indicating to which server among the servers included in the data center LAN 2 is to be transferred a request and data, etc., transmitted from the mobile telephone 1 that accessed the distribution server 3. For example, if a client ID that has been transmitted from the mobile telephone 1 to the distribution server 3 is “101”, it can be understood that the access destination of a request, etc. transmitted from the mobile telephone 1 is 192.168.0.101, and the request, etc., from the mobile telephone 1 is transferred to the virtual server 6 having this access destination as its IP address.

FIG. 3 is an example of an authentication table.

The authentication table has been stored in the application database 8. The authentication table stores user names and passwords in correspondence with identification numbers. Data representing a user name and data representing a password is transmitted from the mobile telephone 1 to the data center LAN 2. Authentication processing is executed to determine, based upon whether the user name and password represented by the transmitted data have been stored in the authentication table, whether the user of mobile telephone 1 has the right to access the data center LAN 2 (either company-A LAN 11 or company-B LAN 21).

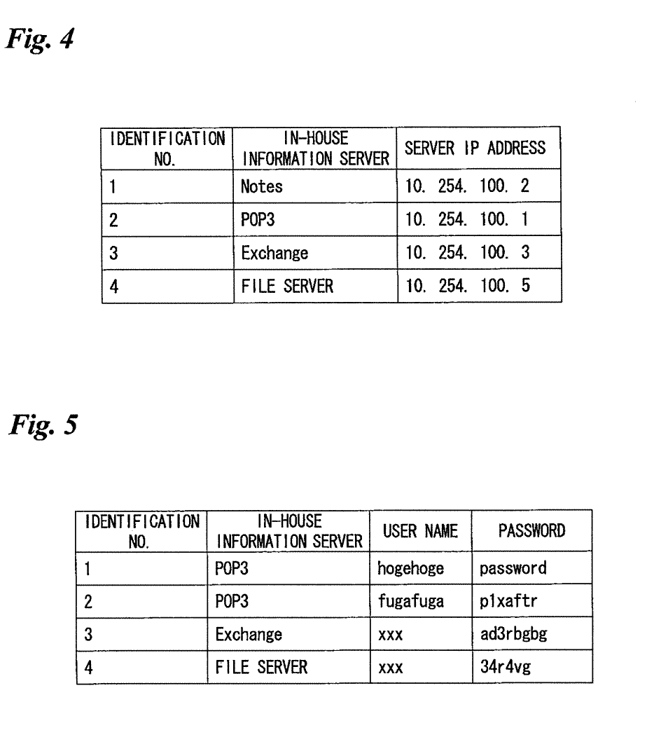

FIG. 4 is an example of an application table.

The application table also has been stored in the application database 8. The application table is provided in correspondence with the client (company A or company B). The application table shown in FIG. 4 is for company A. The application table stores in-house information servers and server IP addresses (IP addresses of in-house information servers) in correspondence with identification numbers. If the company to which the user of mobile telephone 1 belongs as an employee is known, then reference is had to the application table of this company. Based upon a request from the mobile telephone 1, it can be determined to which in-house information server among the in-house information servers connected to the company LAN access is being requested. The server IP address of the in-house information server to which access is being requested is read from the application table. For example, if the in-house information server to which access is being requested by the mobile telephone 1 is the POP server 12 for company A, then it can be understood that the server IP address of POP server 12 is 10.254.100.1.

FIG. 5 is an example of an application authentication table.

The application authentication table has been stored in the application database 8. An in-house information server and password corresponding to a user name that has been transmitted from the mobile telephone 1 are read from the application authentication table. The user name and the read password are transmitted to the in-house information server that the mobile telephone 1 is attempting to access.

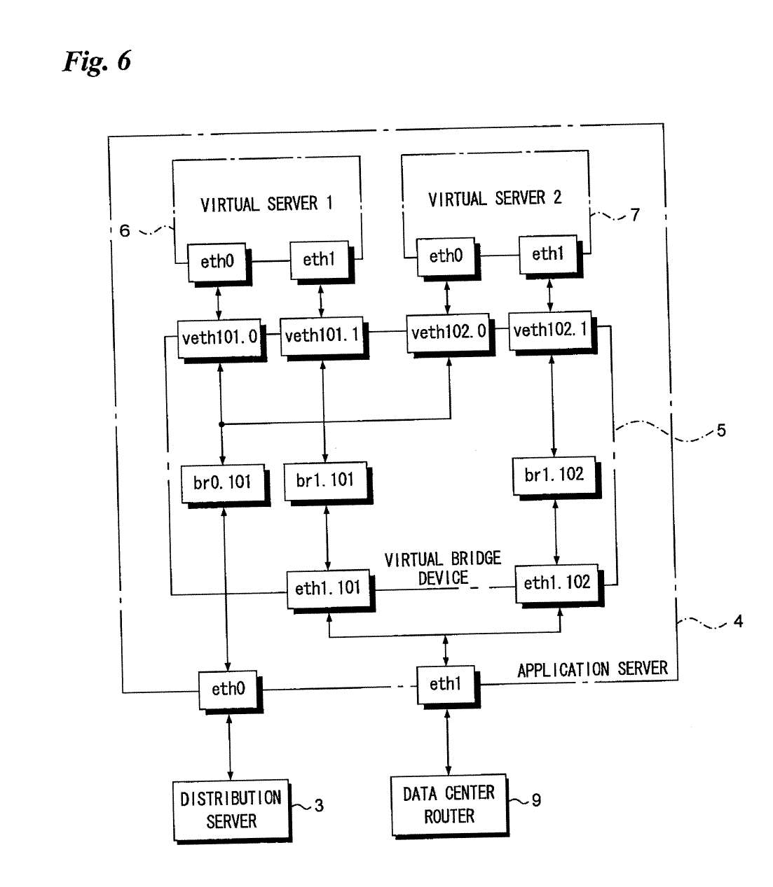

FIG. 6 is a block diagram illustrating the electrical configuration of the application server 4. The application database 8 is not shown in FIG. 6. The distribution server 3 and data center router 9 are illustrated in addition to the application server 4.

The application server 4 includes network interfaces eth0 and eth1, which have been formed physically. The distribution server 3 is connected to the network interface eth0, and the data center router 9 is connected to the network interface eth1.

The network interface eth0 is connected to a first end of a virtual bridge br0.101. The virtual bridge br0.101 (and virtual bridges br1.101, br1.102 described later) is a switch implemented by software. Virtual network interfaces veth101.0 and veth102.0 are connected to a second end of the virtual bridge br0.101. The virtual network interface veth101.0 of virtual bridge device 5 is connected to the virtual network interface eth0 of the virtual server 6. Further, the virtual network interface veth102.0 of the virtual bridge device 5 is connected to the virtual network interface eth0 of the virtual server 7.

The virtual network interface eth1 of virtual server 6 is connected to a virtual network interface veth101.1 of the virtual bridge device 5. The virtual network interface veth101.1 is connected to a virtual network interface eth1.101 of the virtual bridge device 5 via the virtual bridge br1.101.

Similarly, the virtual network interface eth1 of the virtual server 7 is connected to a virtual network interface veth102.1 of the virtual bridge device 5. The virtual network interface veth102.1 is connected to a virtual network interface eth1.102 of the virtual bridge device 5 via the virtual bridge br1.102.

The virtual network interfaces eth1.101 and eth1.102 of the virtual bridge device 5 are connected to the network interface eth1 of the application server 4.

The virtual network interfaces eth1.101 and eth1.102 of the virtual bridge device 5 apply a VLAN tag to a packet of data, etc. applied from the virtual server 6 or 7, and allow data, etc. applied from the data center router 9 to pass if the prescribed VLAN tag has been appended to the packet containing this data, etc. For example, when the virtual server 6 for company A applies data to the virtual network interface eth1.101, a VLAN tag “101” for the company-A LAN 11 is appended to the packet, and when the virtual server 7 for company B applies data to the virtual network interface eth1.102, then a VLAN tag “102” for the company-B LAN 21 is appended to the packet. Further, if a VLAN tag “101” for the company-A LAN 11 has been appended to a packet applied from the data center router 9, then this packet passes through the virtual network interface eth1.101 but it does not pass through the virtual network interface eth1.102. If a VLAN tag “102” for the company-B LAN 21 has been appended to a packet applied from the data center router 9, then this packet passes through the virtual network interface eth1.102 but it does not pass through the virtual network interface eth1.101.

An arrangement implemented using software is illustrated in FIG. 6 in a manner implemented by hardware. The arrangement of FIG. 6 can be implemented suitably using software or hardware.

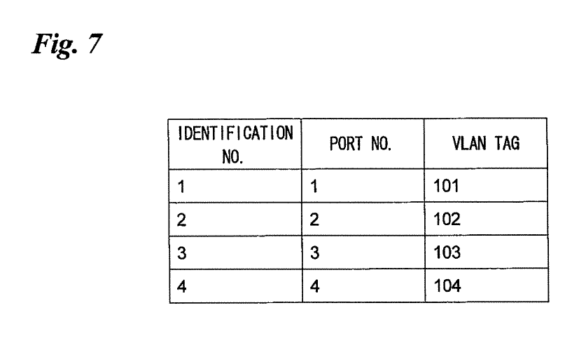

FIG. 7 is an example of a routing table.

The routing table has been stored in the data center router 9. The routing table stores port numbers and VLAN tags in correspondence with identification numbers. A port number identifies a port formed in the data center router 9. Port No. 1 corresponds to port P1, and Port No. 2 corresponds to port P2.

The routing table outputs a packet to the port of the port number conforming to the VLAN tag that has been appended to the packet. With regard to a VLAN tag that has not been appended to a packet, the routing table appends the VLAN tag corresponding to the port number conforming to the port to which the packet has been input, and then outputs the packet.

For example, a packet that has been transmitted from the company-A LAN 11 is input to the data center router 9 from port P1. Since the port number corresponding to port P1 is “1”, VLAN tag “101” corresponding to this port number is read. The VLAN tag “101” read is appended to the packet. Since the packet with the appended VLAN tag “101” passes through the virtual network interface eth1.101 but does not pass through the network interface eth1.102, the packet with the appended VLAN tag “101” is applied to the virtual server 6 for company A. Further, if the VLAN tag “101” has been appended to a packet applied from the application server 4, then the applied packet is output from port P1 since the port number corresponding to the VLAN tag “101” is “1”. Since the company-A LAN 11 has been connected to the port P1, the packet with the appended VLAN tag “101” is transmitted to the company-A LAN 11. Operation is similar with regard to other VLAN tags as well.

Thus it will be understood that by utilizing a VLAN tag, a packet containing a data, command, etc. can be transmitted to the desired LAN, namely the company-A LAN 11 or the company-B LAN 21, and that a packet that has been transmitted from the company-A LAN 11 or the company-B LAN 21 can be transmitted to the virtual server 6 or 7 for the corresponding company.

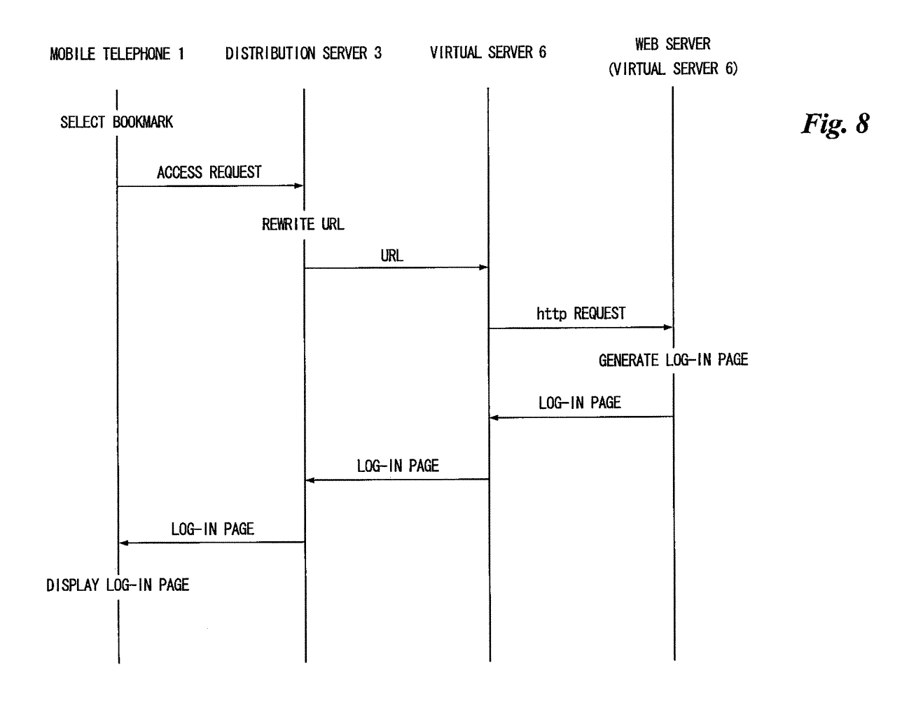

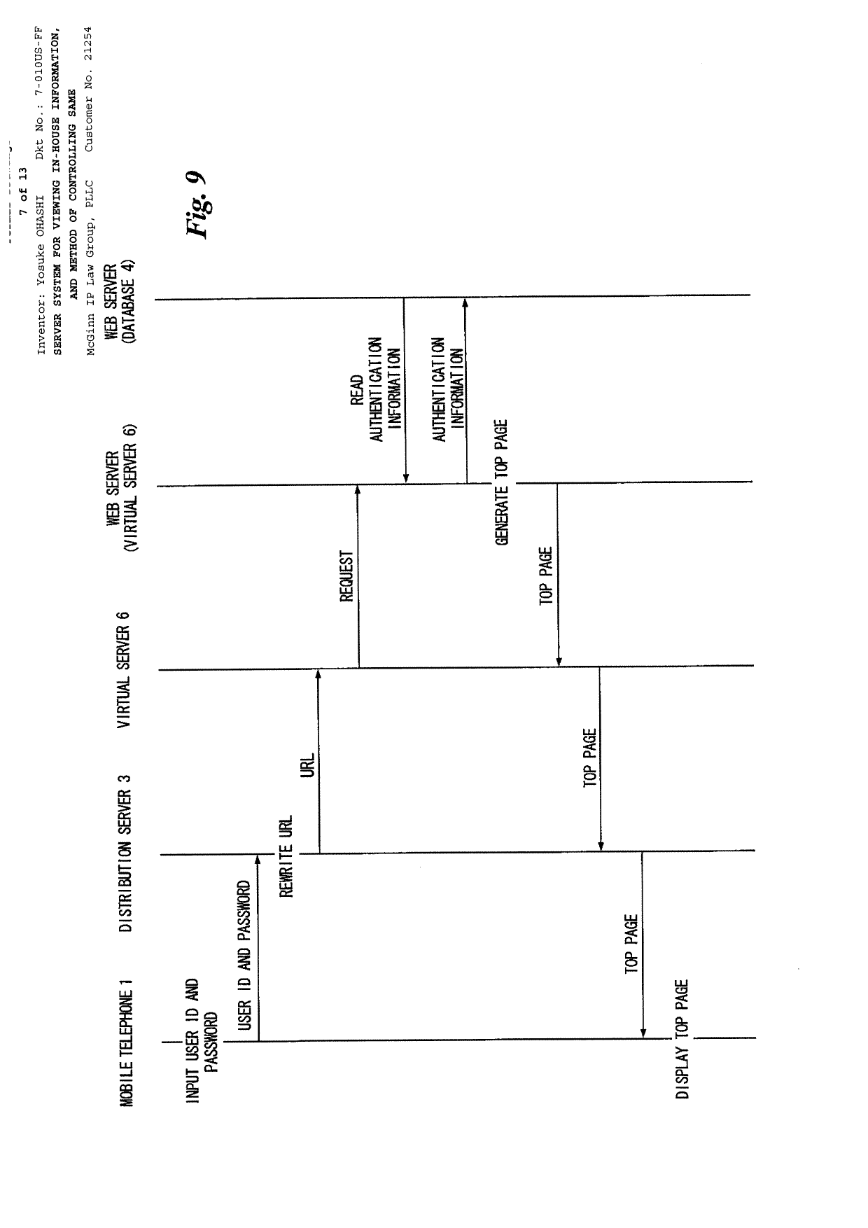

FIGS. 8 and 9 are flowcharts (sequences) illustrating processing in a case where the user of the mobile telephone 1 logs into the data center LAN 2 using the mobile telephone 1.

The user of the mobile telephone 1 logs into the data center LAN 2 by selecting a bookmark or the like that has been registered in the mobile telephone. Naturally, the user may just as well log into the data center LAN 2 by directly inputting the URL (https://mailremote.jp/101/login) of the data center LAN 2.

An access request is transmitted from the mobile telephone 1 to the URL corresponding to the data center LAN 2.

The access request is transmitted to the distribution server 3 having the address “mailremote.jp”. The distribution server 3 rewrites the URL based upon the distribution rule table shown in FIG. 2. For example, when “101” contained in the above-mentioned URL is identified as the client ID, the above-mentioned URL (https://mailremote.jp/101/login) is rewritten to (http://192.168.0.101/login). Based upon the rewritten URL, the distribution server 3 transmits an http (HyperText Transfer Protocol) request to the virtual server 6, which has the IP address “192.168.0.101”.

The http request received by the virtual server 6 is received by the web server (not shown) within the virtual server 6 waiting at Port No. 80, which is generally used in the http protocol. This http request includes data indicating “GET” as the method and “login” as the instruction.

The web server judges from the http request that a command calling for output of a log-in web page has been issued and generates a log-in page in HTML (HyperText Markup Language) for displaying the log-in page. Data representing the generated log-in page is applied to the virtual server 6 from the web server.

The data representing the log-in page generated in the web server is transferred from the virtual server 6 to the distribution server 3.

The distribution server 3 transmits the data representing the log-in page, which has been transmitted from the virtual server 6, to the mobile telephone 1 that transmitted the access request. From the viewpoint of the mobile telephone 1, it is construed that the mobile telephone 1 is communicating directly with the distribution server 3.

Upon receiving the data representing the log-in page transmitted from the distribution server 3, the mobile telephone 1 renders this data using a built-in web browser. When this is done, the log-in page is displayed on the display screen of the mobile telephone 1.

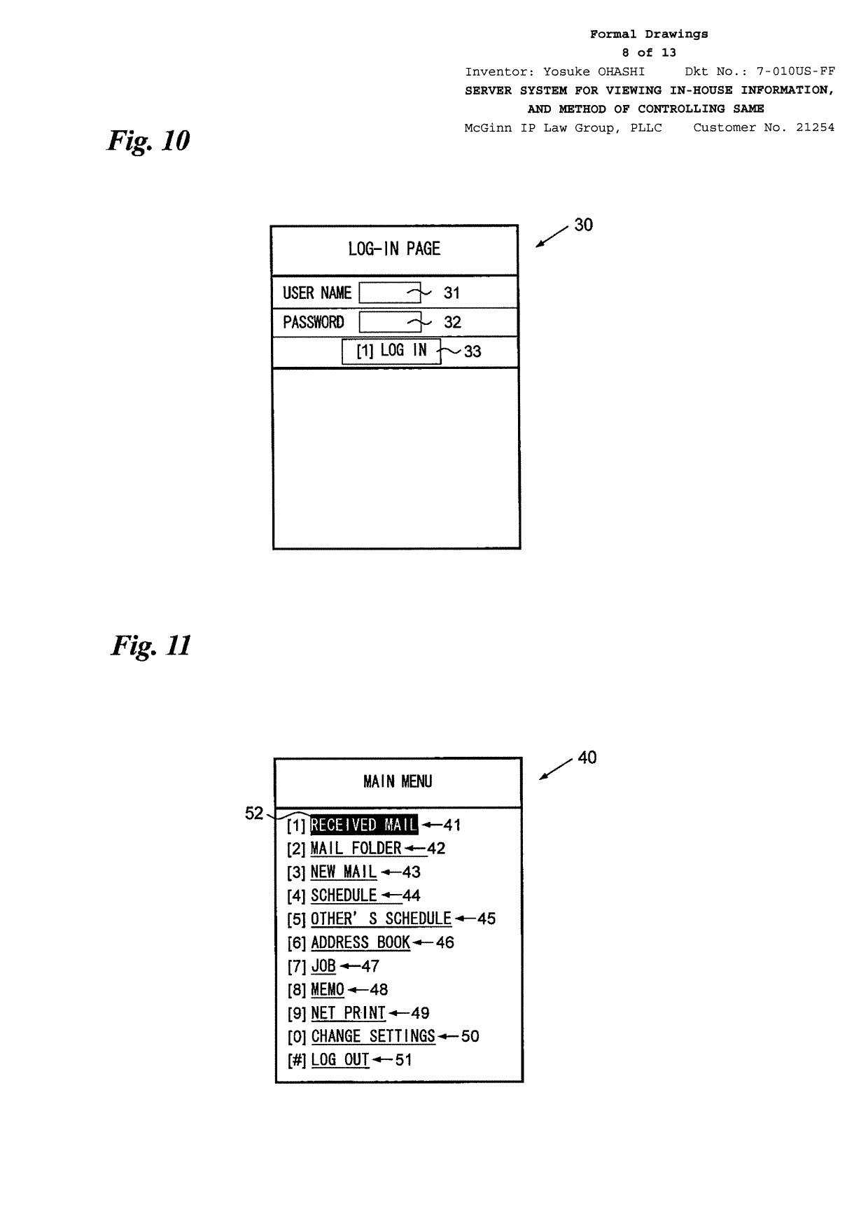

FIG. 10 is an example of a log-in page 30.

The log-in page 30 includes a user name display area 31, a password display area 32 and a log-in button 33. When a cursor (not shown) is positioned at the user name display area 31, characters entered from the keypad of the mobile telephone 1 are displayed in the user name display area 31. Similarly, when the cursor is positioned at the password display area 32, asterisks are displayed in the password display area 32 in accordance with characters entered from the keypad of the mobile telephone 1. When the cursor is positioned on the log-in button 33 and an ENTER button included in the keypad of the mobile telephone 1 is pressed, data representing the entered user name and data representing the entered password is transmitted from the mobile telephone 1 to the distribution server 3.

With reference to FIG. 9, if “hogehoge” is entered as the user name and “password” is entered as the password, for example, then the entered user name and password are transmitted from the mobile telephone 1 to the distribution server 3 along with a log-in request. The entered user name and password are appended as URL parameters and the result is transmitted to the distribution server 3 as the URL representing the request. For example, the URL is https://mailremote.jp/101/login?id=hogehoge&pw=password.

The distribution server 3 rewrites the URL of the log-in request transmitted from the mobile telephone 1 and issues a request for the rewritten URL to the virtual server 6, which has the IP address “192.168.0.101”. The URL at this time is http://192.168.0.101/login?id=hogehoge&pw=password.

In a manner similar to that described above, the request received by the virtual server 6 is received by the web server within the virtual server 6 waiting at Port No. 80 used in http. The http request when it is received includes “GET” as the method and “login?id=hogehoge&pw=password” as the instruction. The parameter id at this time pertains to the user name of data center LAN 2 and the parameter pw pertains to the password of data center LAN 2.

Using the user name and password contained in the http request received, the virtual server 6 refers to the authentication table of FIG. 3 and verifies whether the user of accessing mobile telephone 1 is one having access authorization. More specifically, the virtual server 6 queries the authentication table, which has been stored in the application database, using SQL (Structured Query Language) or the like, and determines that the user has access authorization if the relevant user name and password (authentication information) has been stored in the authentication table.

If the user name and password transmitted from the mobile telephone 1 are contained in the authentication table that has been stored in the application database, then data for displaying the top page is generated by the web server in the virtual server 6. The generated data representing the top page is transmitted from the web server to the virtual server 6.

The virtual server 6 transfers the received data representing the top page to the distribution server 3.

The distribution server 3 transfers the received data representing the top page to the mobile telephone 1.

The top page is displayed on the display screen of the mobile telephone 1.

FIG. 11 is an example of a top page 40.

The distribution server 3 transfers the response from the virtual server to the mobile telephone that issued the request. Character strings indicating contents accessible by the mobile telephone 1 are displayed on the top page 40. A character string 41 indicative of received mail, a character string 42 indicative of a mail folder, a character string 43 indicative of new mail, a character string 44 indicative of a schedule, a character string 45 indicative of another's schedule, a character string 46 indicative of an address book, a character string 47 indicative of work, a character string 48 indicative of a memo, a character string 49 indicative of net printing, a character string 50 indicative of a change in settings, and a character string 51 indicative of log-out are included. Links have been embedded in these character strings 41 to 51. A desired character string is selected by moving a cursor 52. By pressing the ENTER button of the mobile telephone 1, the content of the character string selected by the cursor is designated and the corresponding command is transmitted from the mobile telephone 1 to the distribution server 3.

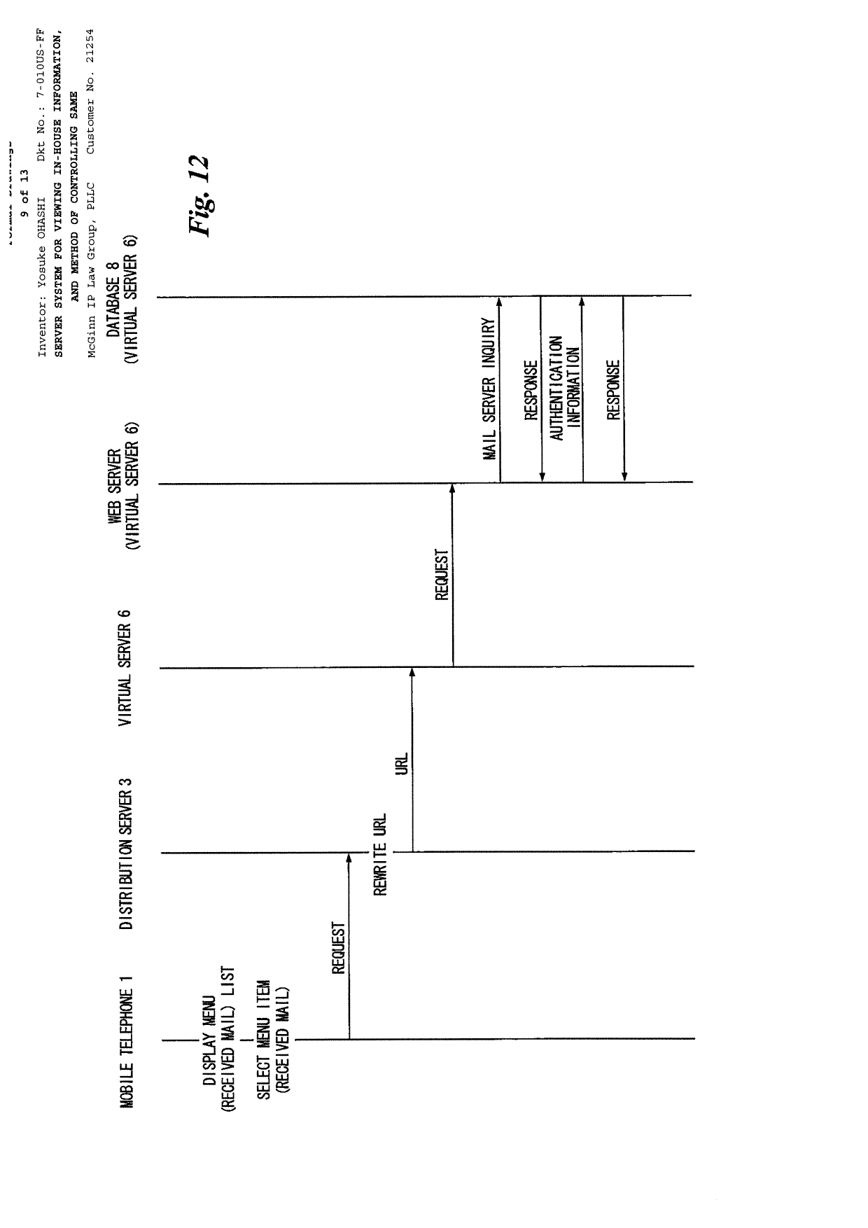

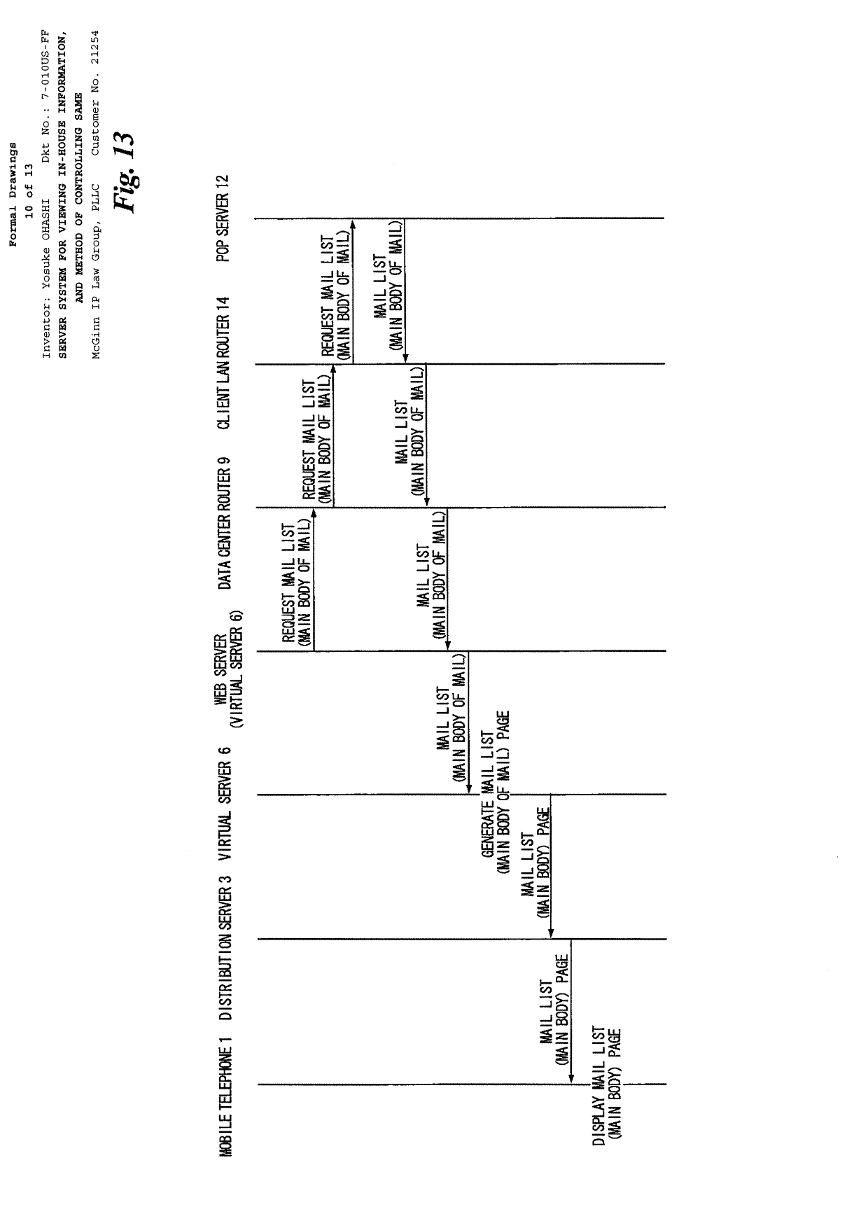

FIGS. 12 and 13 are flowcharts (sequences) illustrating processing for displaying a mail list on the display screen of the mobile telephone 1.

A menu list is displayed by the above-mentioned top page 40 and the character string 41 for received mail contained in the menu is clicked by the user of the mobile telephone 1 to thereby select the received mail item.

When this is done, a request is transmitted to the distribution server 3 based upon the URL of the clicked link. The request transmitted is an URL represented by https://mailremote.jp/101/inbox?id=hogehoge, by way of example. Thus, the URL includes the user name “hogehoge” used at the time of log-in as the user name. The user who accessed the data center LAN 2 can thus be identified.

The distribution server 3 rewrites the URL of the log-in request transmitted from the mobile telephone 1 and issues a request for the rewritten URL to the virtual server 6 having the IP address “192.168.0.101”. The rewritten URL is http://192.168.0.101/inbox?id=hogehoge.

The request received by the virtual server 6 is received by the web server within virtual server 6. The received http request includes “GET” as the method and “inbox?id=hogehoge” as the instruction.

From the character string “inbox” contained in the requested URL, the web server judges that this is a request for displaying the mail list and determines from which server the mail list is to be acquired. The web server obtains the mail server from the application database 8 and acquires the IP address of the server applicable to the request from the application table shown in FIG. 4. In this case, since the client ID is “101”, it is understood that the user of the mobile telephone 1 is an employee of company A and therefore the application table of company A is consulted. Since the requested URL includes the character string “inbox”, it is determined that the request is a request for the mail server, and “10.254.100.1”, which is the server IP address of POP3, is read from the consulted applicable table, and “2” is read from the table as the identification number (this constitutes a response).

The application authentication table that has been stored in the application database 8 is consulted by the web server, and the user name and password for accessing the POP server 12 for company A are read (this constitutes an authentication information inquiry). The password “password” applicable to POP3 is obtained from the user name “hogehoge” that prevailed at log-in (this constitutes a response).

In FIG. 13, the web server of virtual server 6 issues a request for acquisition of a mail list to the IP address of the POP server 12. At the time of the request, use is made of the user name and password obtained from the application authentication table of FIG. 5. It goes without saying that this request is made utilizing a well-known protocol such as POP3.

The mail-list acquisition request from the web server of the virtual server 6 is transmitted from the web server to the data center router 9. As described above, in a case where a data and command, etc. are transmitted to the POP server 12 for company A, the VLAN tag “101” is appended to the packet in the data center router 9. The mail-list acquisition request with the appended VLAN tag “101” is transmitted to the company-A LAN 11 connected to port P1 of the data center router 9.

The mail-list acquisition request transmitted to the company-A LAN 11 is input to the client LAN router 14 for company A. The client LAN router 14 for company A transmits the mail-list acquisition request from the server IP address to the applicable POP server 12.

The mail-list acquisition request is input to the POP server 12 and the mail-list response data is transmitted from the POP server 12 via client LAN router 14 and is input to the data center router 9 from port P1.

The data center router 9 appends the VLAN tag “101” to the packet containing the data representing the mail-list response. The packet with the appended VLAN tag “101” is input to the web server of the virtual server 6 for company A, as described above.

The data representing the mail-list response is transferred to the virtual server 6, which proceeds to generate an HTML page representing the mail list.

The HTML page representing the mail list is transferred to the distribution server 3, which is the origin of the request.

The HTML page representing the mail list is transmitted from the distribution server 3 to the mobile telephone 1, which is the initial origin of the request.

A mail list page is displayed on the display screen of the mobile telephone 1.

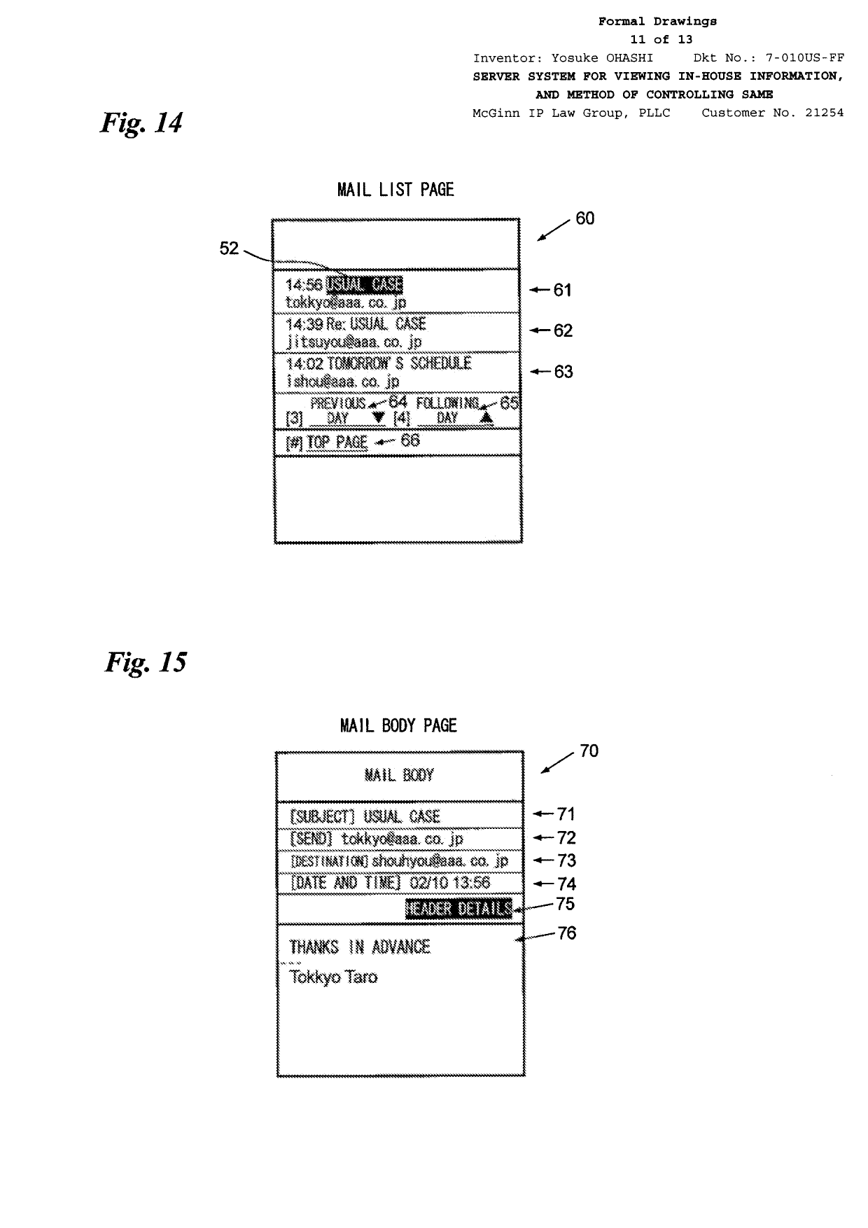

FIG. 14 is an example of a mail list page 60.

A list of a number of e-mails 61 to 63 is being displayed on the mail list page 60. Each of these e-mails 61 to 63 contains the subject name of the e-mail and the address of the user who transmitted the e-mail. The cursor 52 can be moved to any one of the subject names of e-mails 61 to 63 by using the keyboard of the mobile telephone 1. If the ENTER button of the mobile telephone 1 is pressed, the e-mail where the cursor 52 is positioned when the ENTER button is pressed is requested.

The mail list page 60 further includes a character string 64 indicative of the previous day, a character string 65 indicative of the following day, and a character string 66 indicative of the top page. By positioning the cursor 52 on the character string 64 indicative of the previous day and pressing the ENTER button, a list of e-mails from the previous day is requested. By positioning the cursor 52 on the character string 65 indicative of the following day and pressing the ENTER button, a list of e-mails from the following day is requested. If the cursor 52 is positioned on the character string 66 indicative of the top page and the ENTER button is pressed, then the top page is requested.

In order to view a certain e-mail, the subject name of the desired e-mail is clicked on the mail list page 60 in FIG. 14.

The request is transmitted to the distribution server 3 based upon the URL of the clicked link. The transmitted request is the URL https://mailremote.jp/101/inbox/?uid=1&id=hogehoge, by way of example. This URL includes UIDL, which uniquely identifies the viewed e-mail, as the parameter uid, and the user name, which was used at log-in, as the parameter id. The user and the e-mail viewed can be identified. It is preferred that UIDL be incorporated in the link to each e-mail when the mail list page is displayed.

The distribution server 3 rewrites the URL that has been transmitted from the mobile telephone 1 and issues a request for this rewritten URL to the virtual server 6 having the IP address 192.168.0.101. The URL at this time is http://192.168.0.101/inbox?uid=1&id=hogehoge.

The http request received by the virtual server 6 is transmitted to the web server of the virtual server. This http request includes “GET” as the method and “inbox?uid=1&id=hogehoge” as the instruction.

Based upon the URL, the web server judges that this is a request to display the main body of mail and determines from which server the mail body is to be acquired. In a manner similar to that described above, the IP address of the server applicable to the request is acquired from the application table shown in FIG. 4. In this case, in a manner similar to that described above, the IP address of the POP server 12 in the company-A LAN 11, namely “10.254.100.1”, and the identification number “2” are acquired (this constitutes a mail server inquiry).

In a manner similar to that described above, an authentication information inquiry is made and the password of the user name “hogehoge” that prevailed at log-in is acquired.

A request for acquisition of a mail body list is issued from the web server 6 to the acquired IP address of the POP server 12.

Thus, as described above, a request for acquisition of the body of e-mail is transferred from the web server of the virtual server 6 to the data center router 9. The data center router 9 appends the VLAN tag “101” to the request and transfers the request to the company-A LAN 11 connected to port P1.

The request transferred to the company-A LAN 11 is input to the client LAN router 14 of company A, whence the request is transmitted to the POP server 12.

The mail-body acquisition request is input to the POP server 12 and the mail body is output based upon the POP3 protocol.

The mail-body inquiry response is transmitted to the data center router 9, which is the origin of the request, by the client LAN router 14.

The mail-body inquiry response has a VLAN tag appended thereto at the data center router 9 and is input from the web server to the virtual server 6.

An HTML page for displaying the mail body is generated by the virtual server 6 from the mail-body inquiry response.

Data representing the generated HTML page is transferred from the virtual server 6 to the distribution server 3.

The data representing the HTML page transferred to the virtual server is transferred to the mobile telephone 1, which is the original source of the request.

The mail body page is displayed on the display screen of the mobile telephone 1.

FIG. 15 is an example of a mail body page 70.

A subject name 71 of the e-mail, a mail address 72 of the sender of the e-mail, a destination 73, a date and time 74, a character string 75 indicative of header details and e-mail body 76 are being displayed on the mail body page 70. Thus, e-mail that has been stored in the POP server 12 of company A can be viewed using the mobile telephone 1 of an employee of company A.

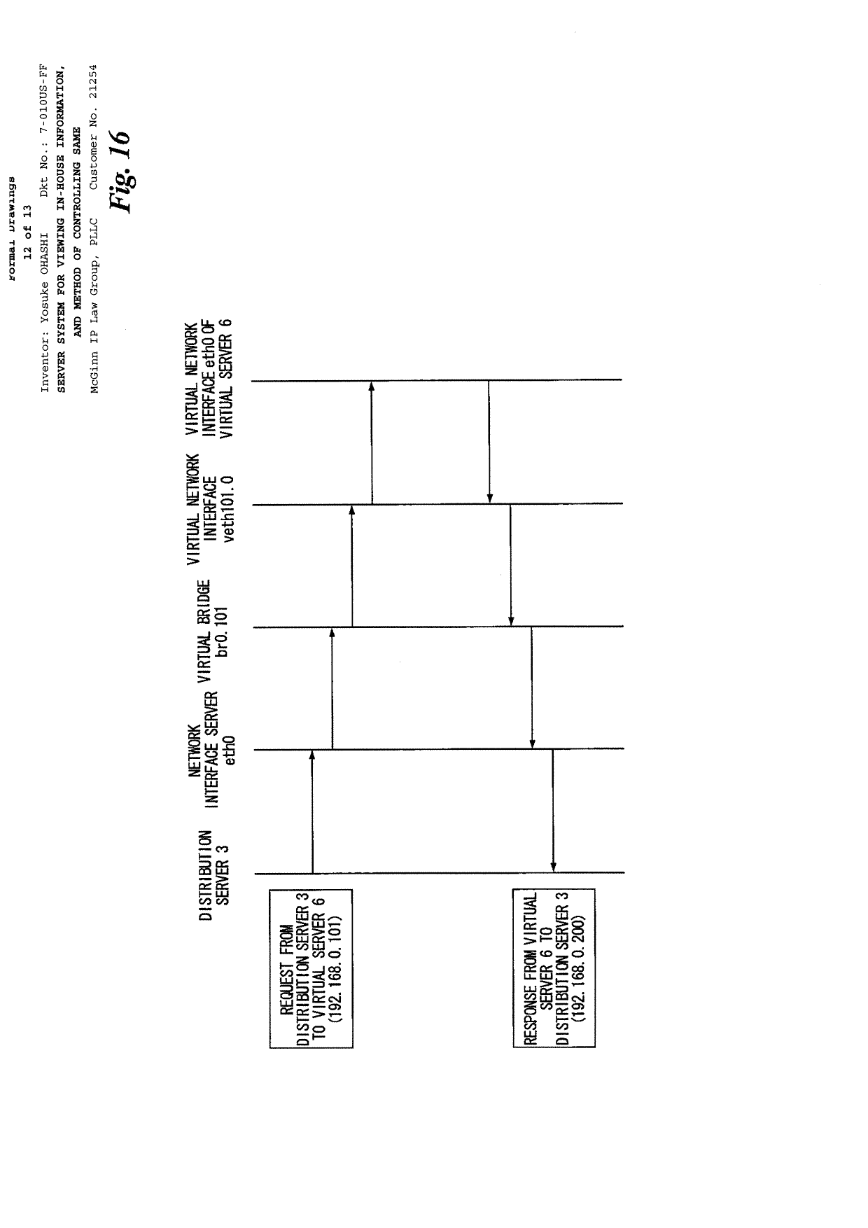

FIG. 16 is a flowchart (sequence) indicating processing executed between the distribution server 3 and the virtual server 6. FIG. 16 illustrates the details of processing executed between the distribution server 3 and virtual server 6 in FIGS. 12 and 13.

With reference also to FIG. 6, the virtual network interface veth101.0 of the virtual bridge device 5 corresponds to the virtual network interface eth0 of the virtual server 6 having the IP address 192.168.0.101. This means that the request from the distribution server 3 to the virtual server 6 is input to the virtual server 6 via the virtual network interface eth0 of the application server, the virtual bridge br0.101, the virtual network interface veth101.0 and the virtual network interface eth0 of the virtual server 6.

The response to this request is output from the virtual network interface eth0 of the virtual server 6. This response is input to the distribution server 3 via the virtual network interface veth101.0 of the virtual bridge device 5 corresponding to the virtual network interface eth0 of the virtual server 6, the virtual bridge br0.101 and the virtual network interface eth0 of the application server. Thus the response to the request from the distribution server 3 to the virtual server 6 is input to the distribution server 3 from the virtual server 6.

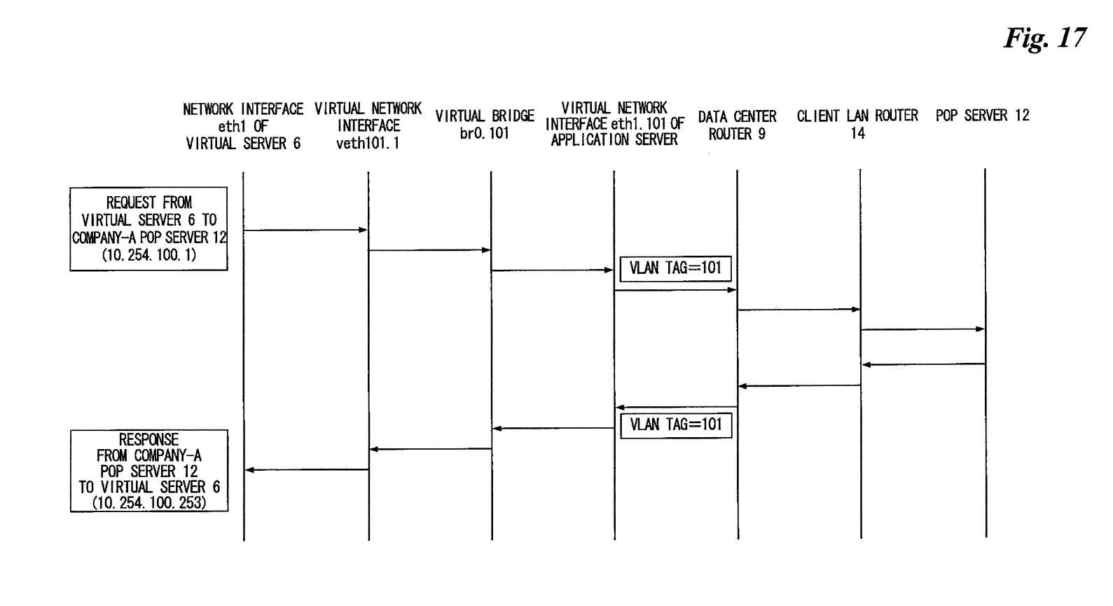

FIG. 17 is a flowchart (sequence) showing processing executed between the virtual server 6 and the POP server 12 of company A. FIG. 17 shows the details of processing executed among the distribution server 3, virtual server 6, data center router 9, client LAN router 14 and POP server 12 in FIG. 13.

With reference also to FIG. 6, the request from the virtual server 6 to the POP server 12 (IP address: 10.254.100.1) within company-A LAN 11 is output from the virtual network interface eth1 of the virtual server 6 and is input to the virtual network interface eth1.101 via the virtual network interface veth101.1 of the virtual bridge device 5 corresponding to this virtual network interface eth1, and the virtual bridge br1.101. The virtual network interface eth1.101 appends the VLAN tag “101” to the packet containing this request. The packet containing the request with the appended VLAN tag “101” is input to the data center router 9 via the virtual network interface eth1 of the virtual server 6.

The data center router 9 determines that the input packet is to be transmitted to the company-A LAN 11. The packet is then transferred from port P1 of data center router 9 to the client LAN router 14 of company A. The packet is input by the client LAN router 14 to the POP server (IP address: 10.254.100.1) in the company-A LAN 11.

Conversely, in a case where a response is transmitted from the POP server 12 in company-A LAN 11 to the virtual server 6, the response is input from the POP server 12 to the data center router 9 via the client LAN router 14. The data center router 9 appends the VLAN tag “101” to the packet containing the response. The packet with the appended VLAN tag “101” passes through the virtual network interface eth1.101 via the virtual network interface eth1 of the application server 4. Since the VLAN tag “101” has been appended to the packet, the packet does not pass through the virtual network interface eth1.102, as mentioned earlier. The packet containing the response is input to the virtual server 6 via the virtual bridge br1.101, the virtual network interface veth101.1 and the virtual network interface eth1 of the virtual server 6. Thus, a response is sent back in answer to a request from the virtual server 6 to the POP server 12.

In the embodiment described above, communication is carried out between the mobile telephone 1 and the POP server 12. However, similar processing can be executed between the mobile telephone 1 and the other servers 13 and 22 to 24.

As many apparently widely different embodiments of the present invention can be made without departing from the spirit and scope thereof, it is to be understood that the invention is not limited to the specific embodiments thereof except as defined in the appended claims.

What is claimed is:

1. A server system for viewing in-house information, the system comprising:
an application server in which a plurality of virtual servers have been formed in correspondence with in-house LANs of clients;
a distribution server, responsive to an access request from a mobile terminal to an in-house information server that has been connected to the respective in-house LAN, for connecting the mobile terminal to a virtual server corresponding to the in-house LAN to which has been connected this in-house information server to which access is requested;
a virtual bridge device for inputting data, which is applied to the virtual server corresponding to the in-house LAN to which has been connected the in-house information server to which access is requested, from the mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data; and
a router for communicating data between said virtual bridge device and the in-house LAN of the client connected to a port that corresponds to the identification data appended by said virtual bridge.

2. The system according to claim 1, further comprising an application software storage device in which application software used in the virtual servers has been stored;
wherein said application server executes the application software that has been stored in said application software storage device.

3. The system according to claim 1, wherein the in-house information server is an e-mail server, a file server or a web server.

4. An application server comprising:
a plurality of virtual servers formed in correspondence with in-house LANs of clients; and
a virtual bridge device for inputting data, which is applied to a virtual server corresponding to an in-house LAN to which has been connected an in-house information server to which access is requested, from a mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data.

5. A method of controlling a server system for viewing in-house information, comprising the steps of:
forming a plurality of virtual servers in correspondence with in-house LANs of clients;
in response to an access request from a mobile terminal to an in-house information server that has been connected to the respective in-house LAN, connecting the mobile terminal to a virtual server corresponding to the in-house LAN to which has been connected this in-house information server to which access is requested;
inputting data, which is applied to the virtual server corresponding to the in-house LAN to which has been connected the in-house information server to which access is requested, from the mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data; and
communicating data between a virtual bridge device and the in-house LAN of the client connected to a port that corresponds to the appended identification data.

6. A method of controlling operation of an application server, comprising the steps of:
forming a plurality of virtual servers in correspondence with in-house LANs of clients; and
inputting data, which is applied to a virtual server corresponding to an in-house LAN to which has been connected an in-house information server to which access is requested, from a mobile terminal, outputting the input data upon appending identification data identifying the in-house LAN to which has been connected the in-house information server to which access is requested, and, by inputting the data with the appended identification data, applying the input data with the appended identification data to the virtual server corresponding to the in-house LAN indicated by this identification data.
